(19) United States
(12) Patent Application Publication
(10) Pub. No.: US 2005/0034020 A1
(43) Pub. Date: Feb. 10, 2005

(54) On-chip diagnostic arrangement and method

(76) Inventors: Michael John Palmer, Southampton (GB); Peter Martin Smith, Winchester (GB); Kelvin Wong, Eastleigh (GB)

Correspondence Address: CARDINAL LAW GROUP, Suite 2000, 1603 Orrington Avenue, Evanston, IL, 60201, US

(21) Appl. No.: 10/867,362

(22) Filed: Jun. 14, 2004

(30) Foreign Application Priority Data
Aug. 7, 2003 (GB) 0318487.6

(51) Int. Cl. G06F 11/00

(52) U.S. Cl. 714/30

(57) ABSTRACT

An arrangement (1301-130p) and method based on an on-chip mechanism to increase the amount of information that can be presented for a given sized diagnostic port (120) by Exclusive-OR compression. It allows the possibility of monitoring an entire internal bus in fewer test runs whilst at the same time making more of the diagnostic port available for tracing control signals. It can reduce the time needed to determine the cause of a chip-related problem.

### FIELD OF THE INVENTION

This invention relates to Integrated Circuits (ICs or ‘chips’), and particularly but not exclusively to Application Specific Integrated Circuits (ASICs) having on-chip diagnostic arrangements.

### BACKGROUND OF THE INVENTION

In the field of this invention it is known that during the bring-up and test of an ASIC design it is invaluable to be able to monitor internal data buses, address buses and control signals within that design through the use of an on-chip diagnostic or debug port. This port can be connected directly to an external logic analyser or oscilloscope and internal chip signals can be multiplexed onto the port so that a trace can be obtained (the multiplexing is integrated as part of the chip design). However, chip pin assignment priority is necessarily given to functional I/Os (inputs/outputs) and power. Often the number of spare pins left over, that can be assigned to a diagnostic port, is severely limited. Traditional methods of diagnostics output the entire bus onto the diagnostic port. However, if the width of an internal bus exceeds that of the diagnostic port, then it is not possible to monitor the entire bus in a single test run. The internal bus must be divided into segments and several test runs must be performed with a different segment multiplexed onto the diagnostic port each time. For instance, to monitor a 128-bit internal data bus through a 32-bit diagnostic port, four separate test runs are needed to trace the entire bus. In addition to this, it is often useful if the trace of the bus is accompanied by a trace of the control signals that operate on that bus. In order to make room for these control signals the size of the internal bus segment being monitored during a test run must be reduced. This results in more test runs required to obtain a complete trace of the internal bus and its control signals. This extends the time necessary for bring-up.

However, this approach has the disadvantage(s) that if the width of an internal bus exceeds that of the diagnostic port, then it is not possible to monitor the entire bus in a single test run. The internal bus must be divided into segments and several test runs must be pertormed with a different segment multiplexed onto the diagnostic port each time.

A need therefore exists for on-chip diagnostics wherein the above-mentioned disadvantage(s) may be alleviated.

### STATEMENT OF INVENTION

In accordance with a first aspect of the present invention there is provided an arrangement for diagnosis in an integrated circuit having a multi-bit bus and a diagnostic port for monitoring the condition of the bus, the arrangement comprising: logic means having inputs coupled to the bus and an output coupled to the diagnostic port, the logic means being arranged to produce at its output a compressed signal representative of the condition of the bus, the compressed signal having a bit-width less than that of the bus.

Preferably, the logic means comprises a plurality p of logic circuits for each producing a logic value from n/p respective bits on the bus, where n represents the bus bit-width and p represents an integer factor of n.

Preferably, the logic means comprises an Exclusive-OR logic arrangement.

Preferably, the bus comprises a data bus.

Preferably, the integrated circuit comprises an ASIC.

In accordance with a second aspect of the present invention there is provided a method for diagnosis in an integrated circuit having a multi-bit bus and a diagnostic port for monitoring the condition of the bus, the method comprising: receiving bits from the bus and producing therefrom in a logic arrangement a compressed signal representative of the condition of the bus, the compressed signal having a bit-width less than that of the bus, and applying the compressed signal to the diagnostic port.

Preferably, the step of producing the compressed signal comprises producing a plurality p of logic values from n/p respective bits on the bus, where n represents the bus bit-width and p represents an integer factor of n.

Preferably, the logic arrangement comprises an Exclusive-OR logic arrangement.

Preferably, the bus comprises a data bus.

Preferably, the integrated circuit comprises an ASIC.

Briefly stated, the present invention allows an on-chip mechanism to increase the amount of information that can be presented for a given sized diagnostic port. It allows the possibility of monitoring an entire internal bus in fewer test runs whilst at the same time making more of the diagnostic port available for tracing control signals. It can reduce the time needed to determine the cause of a chip-related problem.

### BRIEF DESCRIPTION OF THE DRAWING

One method and arrangement for diagnosis in an integrated circuit incorporating the present invention will now be described, by way of example only, with reference to the accompanying drawing, in which:

FIG. 1 shows a schematic circuit diagram of an arrangement for on-chip diagnosis in an integrated circuit.

### DESCRIPTION OF PREFERRED EMBODIMENT

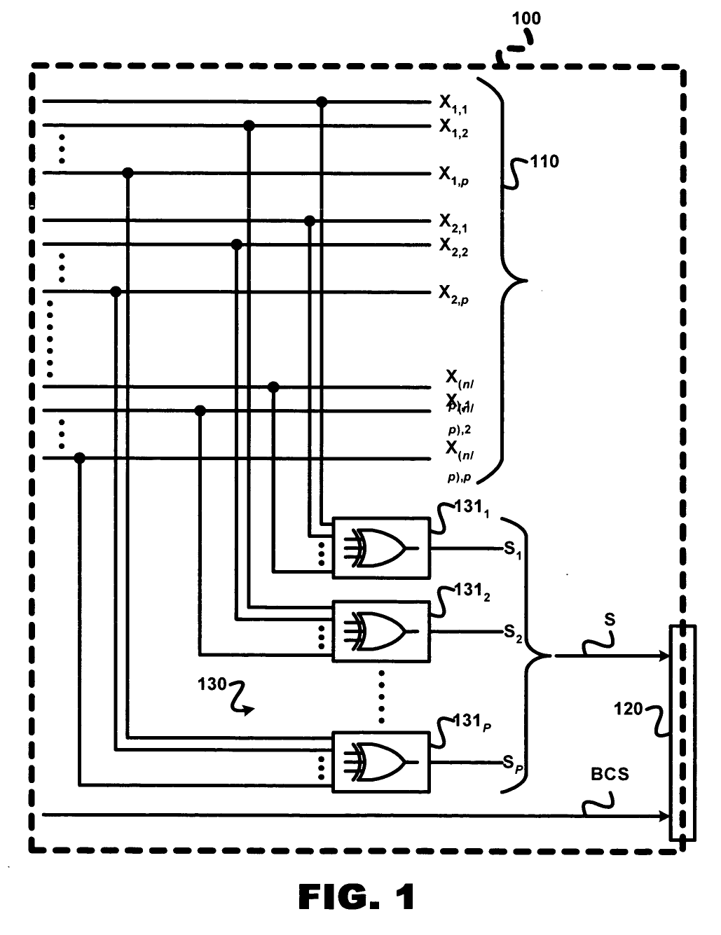

Referring now to FIG. 1, an ASIC 100 has an n-bit bit-width data bus, 110, internal to the chip, which is to be monitored on a diagnostic port 120, p bits of the diagnostic port are allocated to monitor bus 110 (where p is less than the total width of the diagnostic port and p is a factor of n). The bit lines of the data bus 110 are thus divided into n/p groups (X1,1 . . . X1,p; X2,1 . . . X2,p; . . . X(n/p),1 . . . X(n/p),p) each containing p bit lines. From each group, respective ones of the bits lines are connected to identical logic circuitry blocks 1301 . . . 130p, the first bit line of each group (X1,1 . . . X(n/p),1) being connected to the logic circuitry 1301, the second bit line of each group (X1,2 . . . X(n/p),2) being connected to the logic circuitry 1302, etc., and the pth bit line of each group (X1,p . . . X(n/p),p) being connected to the logic circuitry 130p.

In each block 1301 . . . 130p the logic circuitry comprises an Exclusive-OR (XOR) gate (not shown) having n/p inputs coupled to the respective bit lines. Each block 1301 . . . 130p produces a respective single-bit output S1 . . . Sp. As will be explained further below, the p XOR outputs S1 . . . Sp form an ‘XOR signature’, which is applied to respective pins of the diagnostic port 120. Bus control signals generated elsewhere on-chip are applied to other pins of the diagnostic port 120.

Thus, it will be understood that the n-bit data on the bus 110 is compressed into a corresponding p-bit signature, S, which is then passed to the diagnostic port 120. Since p is less than the width of the port, other signals, such as control signals that operate on the bus, can also be presented at the same time.

It is to be noted that more than one data pattern on bus 110 can produce the same XOR signature S. However, it should be borne in mind that the arrangement of FIG. 1 is intended to aid in the diagnosis of problems during the bring-up and test of a chip. During a test run, test data can be chosen to produce only certain expected XOR signatures. Any difference between the signatures recorded at the diagnostic port and the expected signatures will indicate when, in the test run, the problem occurred. As the control signals are also output on the diagnostic port, their state at the time of failure can be ascertained.

As mentioned above, the conventional approach to monitoring internal buses within a chip is to output the whole bus onto the diagnostic port. This means a bus of width 2q bytes will require 2q+3 bits on the diagnostic port. The XOR signature mechanism described in relation to FIG. 1 can be used to compress the pattern on the bus
(by a factor of

$$\frac{{2}^{q + 3}}{p} ,$$

i.e., dependent upon the value of p chosen) so that it fits into a smaller number of bits to allow more room for control signals to be included in the same trace. In addition, bus widths may exceed the width of the diagnostic port, in which case it is impossible to monitor the entire bus using the conventional approach. Instead small segments of the bus must be multiplexed onto the diagnostic port which means that only parts of a bus can be monitored in anyone test run. In order to monitor another part of the bus, another segment must be selected and another test run performed. With the XOR signature mechanism described in relation to FIG. 1, the entire bus can be monitored in a single run provided the test data is carefully pre-selected.

It will be appreciated that various modifications to the compressed signature 25 technique described above will be apparent to a person of ordinary skill in the art. For example, the XOR logic circuitry 1301 . . . 130p could be replaced by another logic block as desired. Alternatively, for example, the compressed signature technique could be applied to monitoring an address bus rather than a data bus.

In conclusion, it will be understood that the compressed signature technique for on-chip diagnosis described above provides the following advantages:
it allows the possibility of monitoring an entire internal bus in fewer test runs whilst at the same time making more of the diagnostic port available for tracing control signals, and
it can reduce the time needed to determine the cause of a chip-related problem.

1-11. (Cancelled)

12. A device, comprising:
a multi-bit bus having a first bit-width;
a diagnostic port for monitoring a condition of the bus; and
a logic arrangement including
inputs coupled to the bus to produce a compressed signal in response to receiving the bits of the bus, wherein the compressed signal is representative of a condition of the bus and wherein the compressed signal has a second bit-width that is less than the first bit-width of the bus, and
at least one output coupled to the diagnostic port to apply the compressed signal to the diagnostic port.

13. The device of claim 12,
wherein n represents the first bit-width of the bus;
wherein p represents the second bit-width of the compressed signal; and
wherein p is an integer factor of n.

14. The device of claim 12,
wherein the logic arrangement is operable to produce a plurality of logic values as a function of a logical compression of the bits of the bus; and
wherein the logic values constitute the compressed signal.

15. The device of claim 12,
wherein n represents the first bit-width of the bus;
wherein the logic arrangement includes a plurality p of logic circuits; and
wherein each logic circuit is operable to produce a logic value from n/p respective bits on the bus.

16. The device of claim 12, wherein the p logic values constitute the compressed signal.

17. The device of claim 12,
wherein p represents the second bit-width of the compressed signal; and
wherein p is an integer factor of n.

18. The device of claim 12, wherein the logic arrangement includes an Exclusive-OR arrangement operable to produce the compressed signal.

19. The device of claim 18,
wherein the Exclusive-OR arrangement includes a plurality of Exclusive-OR gates operable to produce a plurality of logic values as a function of a logical compression of the bits of the bus; and
wherein the logic values constitute the compressed signal.

20. The device of claim 18,
wherein n represents the first bit-width of the bus;
wherein the Exclusive-OR arrangement includes a plurality p of Exclusive-OR gates; and
wherein each Exclusive-OR gate is operable to produce a logic value from n/p respective bits on the bus.

21. The device of claim 20, wherein the p logic values constitute the compressed signal.

22. The device of claim 20,
wherein p represents the second bit-width of the compressed signal; and
wherein p is an integer factor of n.

23. The device of claim 12, wherein the bus is a data bus.

24. A method for a diagnosis of a device including a multi-bit bus having a first bit-width and a diagnostic port for monitoring a condition of the bus, the method comprising:
receiving a plurality of bits from the bus;
producing a compressed signal representative in response to receiving the bits of the bus, wherein the compressed signal is representative of the condition of the bus and wherein the compressed signal has a second bit-width that is less than the first bit-width of the bus; and
applying the compressed signal to the diagnostic port.

25. The method of claim 24,
wherein n represents the first bit-width of the bus;
wherein p represents the second bit-width of the compressed signal; and
wherein p is an integer factor of n.

26. The method of claim 24,
wherein producing the compressed signal includes producing a plurality of logic values as a function of a logical compression of the plurality of bits of the bus; and
wherein the logic values constitute the compressed signal.

27. The method of claim 24,
wherein producing the compressed signal includes producing a plurality p of logic values from n/p respective bits on the bus; and
wherein n represents the first bit-width of the bus.

28. The method of claim 27, wherein the p logic values constitutes the compressed signal.

29. The method of claim 27,
wherein p represents the second bit-width of the compressed signal; and
wherein p is an integer factor of n.

30. A logical arrangement for a diagnosis of a device including a multi-bit bus having a first bit-width and a diagnostic port for monitoring a condition of the bus, the logical arrangement comprising:
means for receiving a plurality of bits from the bus;
means for producing a compressed signal representative in response to receiving the bits of the bus, wherein the compressed signal is representative of the condition of the bus and wherein the compressed signal has a second bit-width that is less than the first bit-width of the bus; and
means for applying the compressed signal to the diagnostic port.

31. The logical arrangement of claim 30,
wherein n represents the first bit-width of the bus;
wherein p represents the second bit-width of the compressed signal; and
wherein p is an integer factor of n.
